(19) United States
(12) Patent Application Publication
(10) Pub. No.: US 2011/0314203 A1
(43) Pub. Date: Dec. 22, 2011

(54) RESOURCE ADJUSTMENT METHODS AND SYSTEMS FOR VIRTUAL MACHINES

(76) Inventors: Lee-Chung CHEN, Sindian City (TW); Hui-Kuang Chung, Taipei City (TW); Chih-Kai Hu, Tucheng City (TW); Chung-Ting Kao, Kaohsiung City (TW)

(21) Appl. No.: 12/956,803

(22) Filed: Nov. 30, 2010

(30) Foreign Application Priority Data
Jun. 18, 2010 (TW) 99119855

(51) Int. Cl. G06F 12/08; G06F 9/455

(52) U.S. Cl. 711/6; 718/1; 711/E12.016

(57) ABSTRACT

Resource adjustment methods and systems for virtual machines (VMs) for use in at least one physical device are provided. First, a first VM having a first resource set and a second VM having a second resource set are respectively enabled to enter a suspended state. A first user space address and a second user space address are respectively obtained from a first VM memory page table corresponding to the first VM and a second VM page table corresponding to the second VM, and a first physical memory address corresponding to the first user space address in the physical device and a second physical memory address corresponding to the second user space address in the physical device are obtained from a Hypervisor. The first user space address is mapped to the second physical memory address by the Hypervisor. Then, the first VM is enabled to enter an execution state, and the second VM is stopped.

### CROSS REFERENCE TO RELATED APPLICATIONS

This application claims priority of Taiwan Patent Application No. 099119855, filed on Jun. 18, 2010, the entirety of which is incorporated by reference herein.

### BACKGROUND OF THE INVENTION

1. Field of the Invention

The disclosure relates generally to resource adjustment methods and systems for virtual machines, and more particularly, to methods and systems that directly perform resource adjustment, such as increasing or decreasing resources for virtual machines (VMs) without turning off the VMs.

2. Description of the Related Art

A VM is a software implementation of hardware on which operating system runs. Users can install operating systems on a VM as if they do on a physical machine. Generally, a physical device may have several resources, such as a central processing unit and memory, in which a part or all of the resources can be allotted to one or more VMs for use. That is, the respective software executed by a specific VM can only use the resources allotted to the specific VM.

In some cases, when the resources of a VM are not enough to meet user's requirements, the resources of the VM have to be adjusted. Conventionally, when the resources of a fully virtualized VM are not enough, since the resource adjustment cannot be performed when the VM is in a power-on state, the VM must be turned off first, before the resource adjustment may be performed. When the VM has to provide uninterrupted services, but need to be turned off due to resource adjustment, the related servers and programs will be force interrupted, resulting in operational inconveniences. In order to reduce the inconveniences due the turning-off of the VM, the timing for turning off the VM must be carefully considered. For example, the VM may be turned off when required resources are minimal or none. Consequently, required resources cannot always be provided to the VM in real time.

In another example of conventional art, the resource adjustment for a partially virtualized VM can be performed without turning off the VM. However, the operating system in the VM and the operating system of the hardware host must be the same, and only some specific operating systems can implement this feature, thus limiting application for VMs.

### BRIEF SUMMARY OF THE INVENTION

Resource adjustment methods and systems for virtual machines are provided.

An embodiment of a resource adjustment method for virtual machines for use in at least one physical device is provided. The at least one physical device includes at least an operating system, a processing unit and a memory, and the at least one physical device has a plurality of resources which can be allotted, a first VM configuration file for running a first VM, and a second VM configuration file for running a second VM. First, the first VM is enabled to enter a suspended state, wherein the first VM has a first resource set among the resources and a first VM memory page table corresponding to the first VM. The second VM is enabled to enter the suspended state, wherein the second VM has a second resource set among the resources and a second VM memory page table corresponding to the second VM. A first user space address is obtained from the first VM memory page table, and a second user space address is obtained from the second VM memory page table. A first physical memory address corresponding to the first user space address in the at least one physical device and a second physical memory address corresponding to the second user space address in the at least one physical device are obtained from a Hypervisor. The first user space address is mapped to the second physical memory address by the Hypervisor. Then, the first VM is enabled to enter an execution state, wherein the running of the first VM runs is based on the first VM memory page table, and the second VM is stopped.

An embodiment of a resource adjustment system for virtual machines for use in at least one physical device is provided. The at least one physical device includes at least an operating system, a processing unit and a memory, and the at least one physical device has a plurality of resources which can be allotted, a first VM configuration file for running a first VM, and a second VM configuration file for running a second VM. The system includes a storage unit storing the first VM configuration file, the second VM configuration file, and a Hypervisor, and a control unit. The control unit enables the first VM to enter a suspended state, wherein the first VM has a first resource set among the resources and a first VM memory page table corresponding to the first VM. The control unit enables the second VM to enter the suspended state, wherein the second VM has a second resource set among the resources and a second VM memory page table corresponding to the second VM. The control unit obtains a first user space address from the first VM memory page table, and a second user space address from the second VM memory page table. The control unit obtains a first physical memory address corresponding to the first user space address in the at least one physical device and a second physical memory address corresponding to the second user space address in the at least one physical device from a Hypervisor, and maps the first user space address to the second physical memory address by the Hypervisor. The control unit enables the first VM to enter an execution state, wherein the running of the first VM runs is based on the first VM memory page table, and stops the second VM.

An embodiment of a machine-readable storage medium comprising a computer program, which, when executed, causes an electronic device to perform a resource adjustment method for virtual machines for use in at least one physical device is provided. The at least one physical device includes at least an operating system, a processing unit and a memory, and the at least one physical device has a plurality of resources which can be allotted, a first VM configuration file for running a first VM, and a second VM configuration file for running a second VM. The computer program product comprises program codes for enabling the first VM to enter a suspended state, wherein the first VM has a first resource set among the resources and a first VM memory page table corresponding to the first VM, program codes for enabling the second VM to enter the suspended state, wherein the second VM has a second resource set among the resources and a second VM memory page table corresponding to the second VM, program codes for obtaining a first user space address from the first VM memory page table, and a second user space address from the second VM memory page table, and obtaining a first physical memory address corresponding to the first user space address in the at least one physical device and a second physical memory address corresponding to the second user space address in the at least one physical device from a Hypervisor, program codes for mapping the first user space address to the second physical memory address by the Hypervisor, program codes for enabling the first VM to enter an execution state, wherein the running of the first VM runs is based on the first VM memory page table, and program codes for stopping the second VM.

In some embodiments, before the second VM is enabled to enter the suspended state, data in a register of the at least one processing unit within the second resource set corresponding to the second VM is recorded to a memory within the second resource set corresponding to the second VM.

In some embodiments, before the first VM is enabled to enter the suspended state, a kernel of a first VM operating system in the first VM is loaded to a memory within the first resource set as a kernel space in the first VM memory page table.

In some embodiments, a physical device having the control unit and the first VM and/or the second VM respectively run with different operating systems.

Resource adjustment methods for virtual machines may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a resource adjustment system for virtual machines of the invention; and

FIG. 2 is a flowchart of an embodiment of a resource adjustment method for virtual machines of the invention.

### DETAILED DESCRIPTION OF THE INVENTION

Resource adjustment methods and systems for virtual machines are provided.

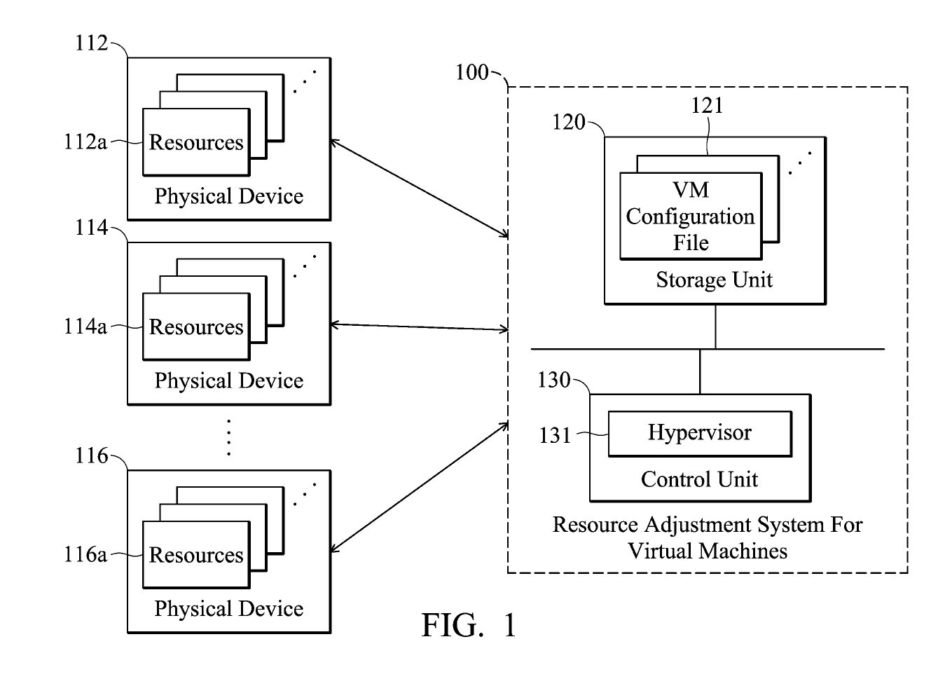

FIG. 1 is a schematic diagram illustrating an embodiment of a resource adjustment system for virtual machines of the invention. The resource adjustment system for virtual machines 100 can be used in at least one physical device, such as a server, a computer, a notebook, a workstation, or any kind of processor-based electronic devices. It is noted that, each physical device can comprise an operating system, a processing unit, and a memory. Generally, the memory of each physical device can be divided into a physical kernel space and a physical user space. The memory of each physical device has a physical device memory page table for recording physical memory addresses respectively corresponding to the kernel space and the user space.

The resource adjustment system for virtual machines 100 comprises a storage unit 120 and a control unit 130. In some embodiments, the resource adjustment system for virtual machines 100 can be set in an independent device, and connected to one or more physical devices (112, 114 and 116). In some embodiments, the resource adjustment system for virtual machines 100 may be one of the physical devices (112, 114 and 116), which can allot the resources (112a, 114a and 116a) therein. The resources can be related hardware components, such as a processing unit and memory which can be allotted to VMs. The storage unit 120 can comprise VM configuration files 121 corresponding to respective VMs. The VM configuration files 121 can at least define the resources corresponding to the respective VMs. For example, a VM configuration file corresponding to a VM can define a processing unit and a memory with 1 G in size for the VM.

The control unit 130 can execute a Hypervisor 131 to obtain a first physical memory address corresponding to the first user space address in the at least one physical device and a second physical memory address corresponding to the second user space address in the at least one physical device, and map the first user space address to the second physical memory address by the Hypervisor. It is understood that, in some embodiments, the Hypervisor can be generated by an operating system or related software, and be provided to the control unit 130 for use.

For example, when at least one physical device runs a second VM based on a second VM configuration file, and the resources of the second VM is needed to be adjusted, the resource adjustment system for virtual machines 100 can run a first VM based on a first VM configuration file. In this embodiment, the Hypervisor 131 can record the mapping relationship between the first user space address and the first physical memory address, and the mapping relationship between the second user space address and the second physical memory address. Then, the Hypervisor 131 can map the first user space address to the second physical memory address, in which the mapping relationship between the user space address and the physical memory address can be modified, such that all or a part of the first physical memory address corresponding to the first user space address recorded in the mapping relationship can be replaced by the second physical memory address. That is, after the modification, the Hypervisor 131 will record all or a part of the first physical memory address to be mapped to the second physical memory address. It is noted that, each VM can have a plurality of resources, such as a VM memory and the corresponding VM memory page table. Similarly, the VM memory can be divided into a kernel space and a user space, which can be mapped to the user space in the physical memory of the physical device. The VM memory page table of the VM and the physical memory table of the physical device can be mapped/translated by the Hypervisor, such that the physical memory address corresponding to the VM memory of each VM can be located.

The control unit 130 can manage related hardware and software in the physical device. In some embodiments, the control unit 130 can manage the resources 112a, 114a and 116a, and run respective VMs based on the corresponding VM configuration files. It is understood that, in some embodiments, the at least one physical device and the respective VMs can run based on respective operating systems, and the respective operating systems may be different. That is, the operating system of the physical device and that of the VM may be different, and the operating systems of the respective VMs may be also different. The control unit 130 can perform the resource adjustment methods for virtual machines of the invention, which will be discussed further in the following paragraphs. It is noted that, the storage unit 120 and the control unit 130 can be located in a specific electronic device. In some embodiments, the specific electronic device can be one of the above physical devices. In some embodiments, the specific electronic device may be a device independent from the above physical devices.

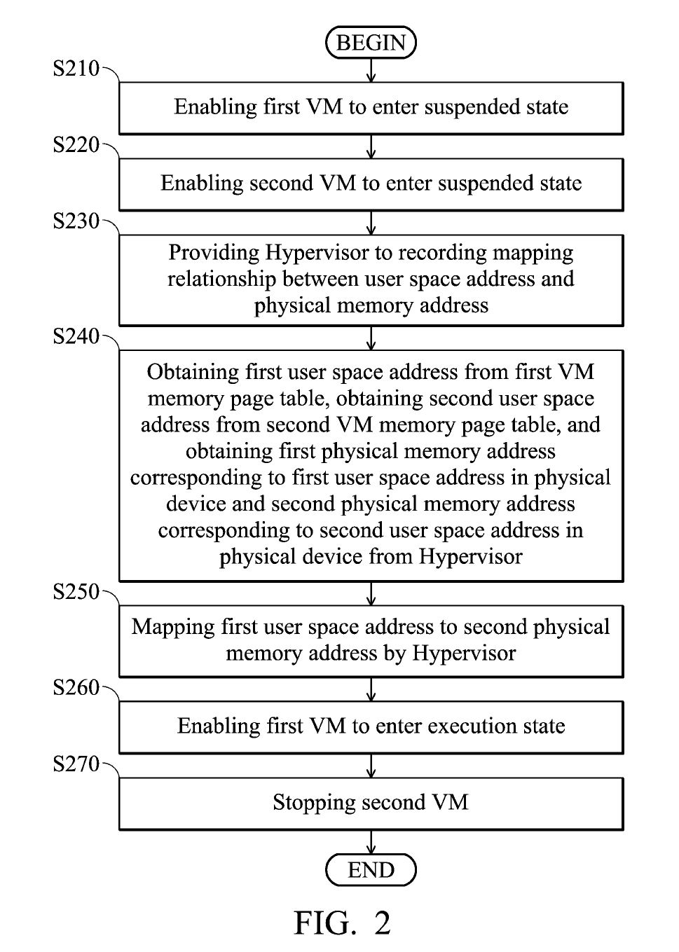

FIG. 2 is a flowchart of an embodiment of a resource adjustment method for virtual machines of the invention. In this embodiment, a second VM runs in a physical device based on a second VM configuration file, and a second resource set (the resources, such as a processing unit and a memory in the second VM configuration file) corresponding to the second VM will be adjusted. The second VM has a second VM memory page table. It is noted that, the second resource set may be at least one of the resources which can be allotted in the at least one physical device. Generally, the second VM has a second VM operating system used to generate the second VM memory page table. In this embodiment, the second VM operating system may be different from the operating system of the physical device.

The resource adjustment system for virtual machines 100 can run a first VM based on a first VM configuration file by way of the above physical device which runs the second VM or another physical device. The first VM has a first resource set, in which the resources in the first resource set are the resources for the second VM after the resource adjustment, such as increasing or decreasing resources. The first VM has a first VM operating system used to generate the first VM memory page table. In this embodiment, the first VM operating system may be different from the second VM operating system and the operating system of the physical device.

In step S210, the first VM is enabled to enter a suspended state. It is noted that, before the first VM is enabled to enter the suspended state, an initialization process can be performed for the first VM. It is understood that, in some embodiments, during the initialization of the first VM, a kernel of a first VM operating system in the first VM can be loaded to a memory within the first resource set as a kernel space in the first VM memory page table. After the kernel corresponding to the first VM is loaded to the memory, the first VM is enabled to enter the suspended state.

In step S220, the second VM is enabled to enter the suspended state. In some embodiments, before the second VM is enabled to enter the suspended state, data in a register of a processing unit within the second resource set corresponding to the second VM can be recorded to a memory within the second resource set corresponding to the second VM.

In step S230, the mapping relationship between the first user space address and the first physical memory address, and the mapping relationship between the second user space address and the second physical memory address are recorded by a Hypervisor. Further, the Hypervisor can obtain the first physical memory address corresponding to the first user space address and the second physical memory address corresponding to the second user space address according to the physical device memory page table of the physical device. It is understood that, in some embodiments, step S230 can be omitted.

In step S240, a first user space address of the first VM is obtained from the first VM memory page table, and a second user space address of the second VM is obtained from the second VM memory page table, and a first physical memory address corresponding to the first user space address in the physical device and a second physical memory address corresponding to the second user space address in the physical device are obtained from the Hypervisor. In some embodiments, the Hypervisor can look up the physical device memory page table of the physical device to obtain the first physical memory address and the second physical memory address in the physical device. It is noted that, as described, the VM memory corresponding to the second VM may have a kernel space and a user space, and step S240 is mainly used to find the user space, with the exception of the kernel space of the second VM.

Then, in step S250, the first user space address is mapped to the second physical memory address by the Hypervisor. In the embodiment, in which step S230 is not omitted, the Hypervisor can modify the mapping relationship therein, such that all or a part of the first physical memory address corresponding to the first user space address recorded in the mapping relationship can be replaced by the second physical memory address.

It is understood that, in some embodiments, when the first resource set of the first VM is less than the second resource set of the second VM, for example, the purpose of resource adjustment of the second VM is to decrease the memory for the second VM, a third physical memory address which is used in the second physical memory address can be located from the second VM memory page table, and the first user space address is mapped to the third physical memory address by the Hypervisor. In the embodiment, in which step S230 is not omitted, the Hypervisor can modify the mapping relationship therein, such that all or a part of the first physical memory address corresponding to the first user space address recorded in the mapping relationship can be replaced by the third physical memory address.

In step S260, the first VM is enabled to enter an execution state, wherein the running of the first VM is based on the first VM memory page table. Then, in step S270, the second VM is stopped. Furthermore, after the second VM is stopped, the resources in the second resource set can be released. In the present application, the VM user space address and the physical memory address of the physical device can be obtained by the Hypervisor, and the user space address of the new VM is mapped to the physical memory address of the old VM, such that the status of the old VM can be transferred to the new VM, and the resource set corresponding to the new VM is used as the resources after adjustment.

An example follows. It is assumed that the resources of a second VM (old VM) include a processing unit and a memory with 1 G in size. When the resources of the second VM are needed to be adjusted into two processing units and a memory with 2 G in size, a first VM configuration file corresponding to a first VM (new VM) is first generated, wherein the first VM configuration file defines two processing units and a memory with 2 G in size. Then, the running of the first VM is based on the first VM configuration file, the first VM and the second VM are enabled to enter to the suspended state, and all or a part of the first physical memory address corresponding to the first user space address of the first VM recorded in the mapping relationship can be replaced by the second physical memory address corresponding to the second user space address of the second VM. By the Hypervisor, the first VM can access related data of the original second VM, and the other user space in the first VM memory page table is the extended space. Then, the first VM is enabled to enter the execution state to run normally. Finally, the processing procedure of the second VM is stopped, and the resources of the second VM can be further released.

Therefore, the resource adjustment methods and systems for virtual machines can directly perform the resource adjustment for VMs without turning off the VMs. In the present invention, the inconveniences due to the interruption of services can be avoided, and the use rate of related resources, such as the processing and storage hardware can be raised. Further, the whole performance of the electronic device/hardware host can be also improved.

Resource adjustment methods for virtual machines, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. When implemented on a general-purpose processor, the program code combines with the processor to provide a unique apparatus that operates analogously to the application of specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A resource adjustment method for virtual machines (VMs) for use in at least one physical device, wherein the at least one physical device includes at least an operating system, a processing unit and memory, and the at least one physical device has a plurality of resources which can be allotted, a first VM configuration file for running a first VM, and a second VM configuration file for running a second VM, and wherein the method comprises:
enabling the first VM to enter a suspended state, wherein the first VM has a first resource set among the resources and a first VM memory page table corresponding to the first VM, and the first VM is run by one of the at least one physical device;
enabling the second VM to enter the suspended state, wherein the second VM has a second resource set among the resources and a second VM memory page table corresponding to the second VM, and the second VM is run by one of the at least one physical device;
obtaining a first user space address from the first VM memory page table, obtaining a second user space address from the second VM memory page table, and obtaining a first physical memory address corresponding to the first user space address in the at least one physical device and a second physical memory address corresponding to the second user space address in the at least one physical device from a Hypervisor;
mapping the first user space address to the second physical memory address by Hypervisor;
enabling the first VM to enter an execution state, wherein the running of the
first VM is based on the first VM memory page table; and stopping the second VM.

2. The method of claim 1, wherein the Hypervisor records a mapping relationship between the first user space address and the first physical memory address, and a mapping relationship between the second user space address and the second physical memory address, and the mapping of the first user space address to the second physical memory address is performed by modifying the mapping relationship in the Hypervisor, to replace all or a part of the first physical memory address corresponding to the first user space address recorded in the mapping relationship by the second physical memory address.

3. The method of claim 2, wherein the Hypervisor obtains the first physical memory address corresponding to the first user space address and the second physical memory address corresponding to the second user space address from a physical device memory page table of the at least one physical device, and accordingly records the mapping relationship.

4. The method of claim 1, wherein the Hypervisor look up a physical device memory page table of the at least one physical device to obtain a first physical memory address corresponding to the first user space address and a second physical memory address corresponding to the second user space address in the at least one physical device.

5. The method of claim 1, further comprising, before the second VM is enabled to enter the suspended state, recording data in a register of the at least one processing unit within the second resource set corresponding to the second VM to a memory within the second resource set corresponding to the second VM.

6. The method of claim 1, wherein before the first VM is enabled to enter the suspended state, loading a kernel of a first VM operating system in the first VM to a memory within the first resource set as a kernel space in the first VM memory page table.

7. The method of claim 1, wherein the resources comprise a processing unit or a memory.

8. The method of claim 1, further comprising:
locating a third physical memory address which is used in the second physical memory address according to the second VM memory page table; and
mapping the first user space address to the third physical memory address by the Hypervisor.

9. The method of claim 8, wherein the Hypervisor records a mapping relationship between the first user space address and the first physical memory address, and a mapping relationship between the second user space address and the second physical memory address, and the mapping of the first user space address to the second physical memory address is performed by modifying the mapping relationship in the Hypervisor, to replace all or a part of the first physical memory address corresponding to the first user space address recorded in the mapping relationship by the third physical memory address.

10. A resource adjustment system for virtual machines (VMs) for use in at least one physical device, wherein the at least one physical device includes at least an operating system, a processing unit and a memory, and the at least one physical device has a plurality of resources which can be allotted, a first VM configuration file for running a first VM, and a second VM configuration file for running a second VM, and wherein the system comprises:
a storage unit storing the first VM configuration file and the second VM configuration file; and
a control unit enabling the first VM to enter a suspended state, wherein the first VM has a first resource set among the resources and a first VM memory page table corresponding to the first VM, enabling the second VM to enter the suspended state, wherein the second VM has a second resource set among the resources and a second VM memory page table corresponding to the second VM, obtaining a first user space address from the first VM memory page table, and a second user space address from the second VM memory page table, obtaining a first physical memory address corresponding to the first user space address in the at least one physical device and a second physical memory address corresponding to the second user space address in the at least one physical device from a Hypervisor, mapping the first user space address to the second physical memory address by the Hypervisor, enabling the first VM to enter an execution state, wherein the running of the first VM runs is based on the first VM memory page table, and stopping the second VM.

11. The system of claim 10, wherein the Hypervisor further records a mapping relationship between the first user space address and the first physical memory address, and a mapping relationship between the second user space address and the second physical memory address, and the mapping of the first user space address to the second physical memory address is performed by modifying the mapping relationship in the Hypervisor, to replace all or a part of the first physical memory address corresponding to the first user space address recorded in the mapping relationship by the second physical memory address.

12. The system of claim 11, wherein the Hypervisor further obtains the first physical memory address corresponding to the first user space address and the second physical memory address corresponding to the second user space address from a physical device memory page table of the at least one physical device, and accordingly records the mapping relationship.

13. The system of claim 10, wherein the Hypervisor further looks up a physical device memory page table of the at least one physical device to obtain a first physical memory address corresponding to the first user space address and a second physical memory address corresponding to the second user space address in the at least one physical device.

14. The system of claim 10, further comprising, before the second VM is enabled to enter the suspended state, the control unit further records data in a register of the at least one processing unit within the second resource set corresponding to the second VM to a memory within the second resource set corresponding to the second VM.

15. The system of claim 10, before the first VM is enabled to enter the suspended state, the control unit further loads a kernel of a first VM operating system in the first VM to a memory within the first resource set as a kernel space in the first VM memory page table.

16. The system of claim 10, wherein the resources comprise a processing unit or a memory.

17. The system of claim 10, wherein the control unit further locates a third physical memory address which is used in the second physical memory address according to the second VM memory page table, and maps the first user space address to the third physical memory address by the Hypervisor.

18. The system of claim 17, wherein the Hypervisor records a mapping relationship between the first user space address and the first physical memory address, and a mapping relationship between the second user space address and the second physical memory address, and the mapping of the first user space address to the second physical memory address is performed by modifying the mapping relationship in the Hypervisor, to replace all or a part of the first physical memory address corresponding to the first user space address recorded in the mapping relationship by the third physical memory address.

19. A machine-readable storage medium comprising a computer program, which, when executed, causes a device to perform a resource adjustment method for virtual machines (VMs) for use in at least one physical device, wherein the at least one physical device includes at least an operating system, a processing unit and a memory, and the at least one physical device has a plurality of resources which can be allotted, a first VM configuration file for running a first VM, and a second VM configuration file for running a second VM, and wherein the method comprises:
enabling the first VM to enter a suspended state, wherein the first VM has a first resource set among the resources and a first VM memory page table corresponding to the first VM, and the first VM is run by one of the at least one physical device;
enabling the second VM to enter the suspended state, wherein the second VM has a second resource set among the resources and a second VM memory page table corresponding to the second VM, and the second VM is run by one of the at least one physical device;
obtaining a first user space address from the first VM memory page table, obtaining a second user space address from the second VM memory page table, and obtaining a first physical memory address corresponding to the first user space address in the at least one physical device and a second physical memory address corresponding to the second user space address in the at least one physical device from a Hypervisor;
mapping the first user space address to the second physical memory address by the Hypervisor;
enabling the first VM to enter an execution state, wherein the running of the
first VM runs is based on the first VM memory page table; and stopping the second VM.
